(19) United States
(12) Patent Application Publication
(10) Pub. No.: US 2016/0075873 A1
(43) Pub. Date: Mar. 17, 2016

(54) ELASTOMER COMPOSITION WITH REDUCED FLAMMABILITY

(71) Applicant: Ticona LLC, Florence, KY (US)

(72) Inventor: Mukul Kaushik, Florence, KY (US)

(21) Appl. No.: 14/797,539

(22) Filed: Jul. 13, 2015

Related U.S. Application Data
(60) Provisional application No. 62/050,386, filed on Sep. 15, 2014.

(51) Int. Cl. C08L 67/00; C09D 167/00

(52) U.S. Cl. CPC C08L 67/00; C09D 167/00; C08L 2205/03; C08L 2205/035

(57) ABSTRACT

A polymer composition is disclosed that contains a thermoplastic elastomer combined with an α-olefin and vinyl acetate copolymer and a flame propagation reducing agent. In one embodiment, the flame propagation reducing agent comprises fluoropolymer particles. The particles have an average particle size of less than about 20 microns, such as less than about 15 microns. In one embodiment, the composition is free of any traditional flame retardants.

### RELATED APPLICATIONS

The present application is based on and claims priority to U.S. Provisional Patent application Ser. No. 62/050,386, filed on Sep. 15, 2014, which is incorporated herein by reference.

### BACKGROUND

Thermoplastic elastomers are a class of useful materials that have a unique combination of properties. The materials, for instance, can be formulated so as to be flexible and tough, while having elastic characteristics. Of particular advantage, the materials can also be melt processed due to their thermoplastic nature. Furthermore, unlike their cross-linked rubber counterparts, thermoplastic elastomers can be recycled and reprocessed.

Thermoplastic elastomers are used in numerous applications. The materials, for instance, may be molded to form a particular part or product or may comprise a component in a product. In addition, these materials may also be over-molded allowing for an additional layer to be formed on an initially molded part. Due to their flexible and elastic nature, thermoplastic elastomers are commonly used in applications where the material constantly undergoes deformation or otherwise contacts other moving parts.

Although thermoplastic elastomers can be used in numerous applications, problems have been experienced in the past in processing the elastomers. For instance, some thermoplastic elastomers have relatively high viscosities that cause problems in filling mold cavities. Other thermoplastic elastomers may have low melt strength which causes issues during extrusion and blow molding. In addition, some thermoplastic elastomers are not only expensive to produce, but also may darken or yellow in color over time. In addition, weathering may also affect the mechanical and thermal properties of the thermoplastic elastomers over time.

In order to correct some of the above noted problems, thermoplastic elastomers have been combined with other polymers. For example, mixtures of thermoplastic elastomers and an ethylene vinyl acetate copolymer have been proposed. Although the combination of the two polymers can lead to a polymer composition having improved overall properties, problems have been experienced in rendering the resulting polymer mixture flame retardant. For instance, ethylene vinyl acetate copolymers have a tendency to increase the flammability of the overall composition due to high oxygen content, low melting temperature, and being made from a flammable olefinic backbone.

In an attempt to make such compositions flame resistant, various flame retardants have been added. Halogen containing flame retardants, however, can produce harsh chemical gases during compounding of the composition and later during molding. Other flame retardants, on the other hand, have a tendency to adversely affect the physical and mechanical properties of the composition due to low molecular weight and phase separation. For instance, some flame retardants can decrease abrasion resistance and scratch resistance due to the formation of a weak interphase and a tendency to shed the flame retardant particles during deformation of the outer layer. The higher interphase area also absorbs more solvents hence adversely affecting the chemical resistance. Inorganic flame retardants can also increase the overall density.

In view of the above, a need exists for an elastomer composition that inhibits flame propagation.

### SUMMARY

In general, the present disclosure is directed to polymer compositions containing a thermoplastic elastomer blended and/or compounded with a second polymer, such as an α-olefin and vinyl acetate copolymer, and further containing a flame propagation reducing agent. The flame propagation rate reducing agent comprises, in one embodiment, fluoropolymer particles having a relatively small particle size.

In one embodiment, for instance, the flame propagation reducing agent comprises fluoropolymer particles comprising a polytetrafluoroethylene polymer. The particles have a size such that at least about 50% of the particles have a diameter of less than about 20 microns, such as less than about 15 microns, such as less than about 10 microns, such as even less than about 5 microns. The particle size of the flame propagation reducing agent, as used herein, is determined using a laser diffraction technology based particle analyzer. Another technique that can be used is Hegman ASTM D-1210. In one embodiment, the flame propagation reducing agent is added to the composition in an amount sufficient such that the polymer composition has a horizontal burn time of greater than about 60 seconds, such as greater than about 65 seconds, such as even greater than about 70 seconds when tested at a length of 75 mm. The Horizontal Burn Test, as used herein, refers to the horizontal burn test used by Underwriters Laboratories, and is typically referred to as a UL 94 flame rating: horizontal testing (HB). According to this test, a specimen is supported in a horizontal position and tilted at 45° C. The test specimen is approximately 0.8 mm thick, 13 mm wide and 125 mm long. Three measurements are done for each formulation. A flame is applied to the end of the specimen and removed until it reached 25 mm mark. Then the sample is allowed to burn until the flame reaches another 75 mm mark. If it takes at least 60 seconds to burn the 75 mm length, the specimen receives the “HB” rating.

In one embodiment, the flame propagation reducing agent is present in the composition in an amount sufficient so as to increase the horizontal burn time for a length of 75 mm by at least 10%, such as by at least 12%, such as by at least 15%, such as by at least 17%, such as at least by 20%, in comparison to an identical composition not containing the flame propagation reducing agent.

In one embodiment, the composition contains the flame propagation reducing agent in an amount of from about 0.5% to about 5% by weight, such as in an amount from about 1% to about 3% by weight. In addition to the flame propagation reducing agent, the composition may also contain an ultrahigh molecular weight silicone.

In one embodiment, the α-olefin and vinyl acetate copolymer contains vinyl acetate units in an amount from about 3 weight % to about 50 weight %, such as from about 10 weight % to about 40 weight %, such as from about 18 weight % to about 40 weight %. The weight ratio between the thermoplastic polyester elastomer and the α-olefin and vinyl acetate copolymer can be from about 10:90 to about 90:10, such as from about 20:80 to about 80:20. In one embodiment, the weight ratio between the two polymers can be from about 25:75 to about 49:51 or from about 75:25 to about 51:49.

Of particular advantage, the polymer composition of the present disclosure can have the above described reduced flame propagation properties without containing any traditional flame retardants. For instance, the composition can be free of any chlorine or bromine-based flame retardants, phosphorus-based flame retardants, or nitrogen-based flame retardants. In one embodiment, however, such flame retardants may be present.

In one embodiment, the α-olefin and vinyl acetate copolymer comprises an ethylene vinyl acetate copolymer. The resulting polymer composition can have a melt flow rate at 190° C. and at 2.16 kg of greater than about 0.1 g/10 mins, such as greater than about 1 g/10 mins, such as greater than about 2 g/10 mins. but less than about 12 g/10 mins, such as less than about 10 g/10 mins, such as less than about 8 g/10 mins., such as less than about 6 g/10 mins.

The thermoplastic elastomer may comprise a thermoplastic polyester elastomer, such as a multi-block copolyester elastomer. The thermoplastic polyester elastomer may contain soft segments and hard segments. The hard segments may comprise ester units, while the soft segments may comprise an aliphatic polyester or a polyether glycol. In one embodiment, the thermoplastic polyester elastomer has the following formula: -[4GT]x[BT]y, wherein 4G is 1,4-butane diol, B is poly(tetramethylene ether glycol) and T is terephthalate, and wherein x is about 0.6 to about 0.99 and y is about 0.01 to about 0.40.

The polymer composition may comprise an antioxidant. The antioxidant may comprise a sterically hindered phenol. The polymer composition may also comprise a light stabilizer. The light stabilizer may comprise a sterically hindered amine. The polymer composition may also comprise a UV absorber. The UV absorber may comprise a benzotriazole or benzophenone.

The polymer composition of the present disclosure can be used to produce numerous articles. In one embodiment, the polymer composition may comprise a coating on a wire or may be used as a component in an electrical device.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a wire or cable made in accordance with the present disclosure;

FIG. 2 is a perspective view of a cover for a mobile phone made in accordance with the present disclosure; and

FIG. 3 is a perspective view of a cable connector that may have a sleeve made from the composition of the present disclosure which prevent or inhibit kinks in the sleeve.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to flame resistant polymer compositions that contain a thermoplastic elastomer combined with a second polymer, such as an α-olefin and vinyl acetate copolymer. Polymer compositions made according to the present disclosure are not only resistant to flame propagation but are also flexible and can have elastic properties. The polymer compositions of the present disclosure can be formulated so as to have the physical properties of a thermoplastic elastomer while having improved and controlled flow properties.

In general, the polymer composition of the present disclosure contains a thermoplastic elastomer blended with a second polymer, such as an α-olefin and vinyl acetate copolymer, and combined with a flame propagation reducing agent. The flame propagation reducing agent is present in the composition an amount sufficient to improve the performance of the composition when tested according to the Horizontal Burn Test. In one embodiment, the flame propagation reducing agent comprises fluoropolymer particles having a relatively small particle size. It is believed that the small particles allow the flame propagation reducing agent to disperse throughout the polymer composition during compounding. During molding into a product or article, it is believed that the flame propagation reducing agent travels to the surface not only improving the surface properties of the product, but also reducing the amount of oxygen available to the polymers present in the composition during exposure to an open flame.

For example, when tested according to Underwriters Laboratories Test 94 according to the 75 mm Horizontal Burn Test, the polymer composition can have a burn time of greater than about 60 seconds, such as greater than about 65 seconds, such as even greater than about 70 seconds. The burn time may depend on various factors including the other components contained in the composition. In general, the flame either extinguishes during the test or has a burn time of less than about 5 minutes, such as less than about 4 minutes.

The flame propagation reducing agent, in one embodiment, can be incorporated into the composition such that the 75 mm Horizontal Burn Test time increases by at least 10%, such as by at least 15%, such as by at least about 20%, such as by at least about 25%, such as by at least about 30%, such as at least by about 40% in comparison to an identical composition not containing the flame propagation reducing agent.

In addition to improving the flame propagation properties of the polymer composition, the flame propagation reducing agent may provide various other benefits and advantages. For instance, articles and products made from the polymer composition can have improved haptics/tactile feel while preserving overmolding adhesion, mechanical properties, processability, and appearance. The presence of the flame propagation reducing agent can improve processing and mold release, which in turn may reduce injection molding cycle time. Of particular advantage, the above flame propagation properties can be improved without having to incorporate a flame retardant into the composition, such as a halogen-based flame retardant, phosphorus-based flame retardant, or nitrogen-based flame retardant. Flame retardants, for instance, can adversely affect the physical and mechanical properties of the composition due to low molecular weight and phase separation. Ultimately, the presence of the flame retardants can create poor abrasion and scratch resistance due to weak interphase and a tendency of the composition to shed the inorganic particles during deformation of the outer layer. The flame propagation reducing agent of the present disclosure, on the other hand, not only lowers surface tension and lowers the coefficient of friction, but produces a surface having a uniform morphology, while improving abrasion and scratch resistance.

In addition, the polymer composition of the present disclosure has many useful and beneficial physical properties due to the combination of the thermoplastic elastomer and the α-olefin and vinyl acetate copolymer. Blending the two polymers together, for instance, produces a composition having improved flow properties. The polymer composition may also have excellent melt strength.

Also of advantage is that compositions made according to the present disclosure can be tailored to achieve desired physical properties, such as flexural modulus. The ratio of the thermoplastic elastomer to the α-olefin and vinyl acetate copolymer, for instance, can be varied in order to produce articles having physical properties within narrow tolerance limits. The resulting polymer composition can also be formulated so as to have desired physical properties over a wide temperature range.

Polymer compositions made in accordance with the present disclosure can be used in numerous and diverse applications. The polymer composition, for instance, can be used as a coating on a surface such as for refrigerators, garage doors, window panels, ceiling grids, and the like. Alternatively, various articles and products can be produced from the polymer composition. For example, since the polymer composition is thermoplastic in nature, the polymer composition can be molded into any suitable shape using, for instance, injection molding, blow molding, or extrusion. The polymer composition may be molded using over-molding or a soft-touch 2-shot over-molding process. In addition, the polymer composition and article produced therefrom may provide increased weldability for joint and heat sealing. Freestanding articles can be produced from the polymer composition or the polymer composition can form a coating or component on or in a product.

In one embodiment, for instance, the polymer composition may be used to produce coatings for wires. As used herein, a wire is referred to as any multi-layer article that has a linear configuration. The term wire, for instance, includes cables and all flexible threads or rods that include a core covered by a coating.

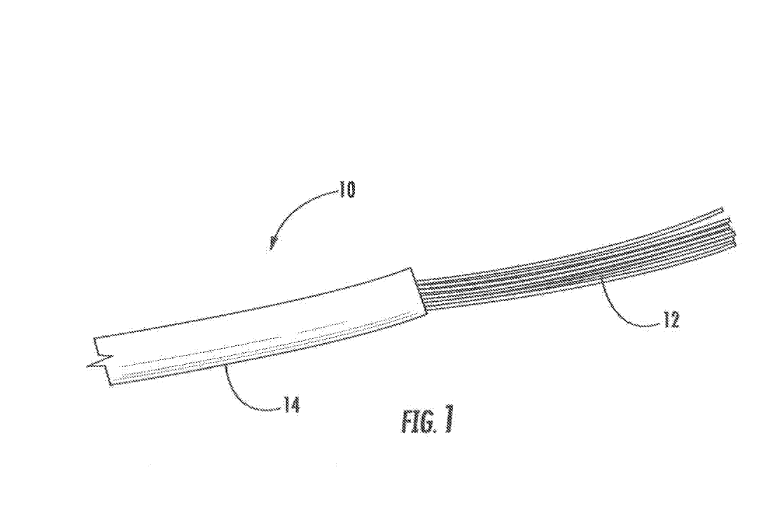

Referring to FIG. 1, for instance, one embodiment of a wire 10 in accordance with the present disclosure is shown. As illustrated, the wire 10 includes a core 12 that can be made from one or more metal elements. In the embodiment illustrated, for instance, the core 12 is made from multiple threads or filaments. The core 12 is surrounded by a coating or sheath 14 made in accordance with the present disclosure. In particular, the flame resistant, polymer composition containing the thermoplastic elastomer in combination with the α-olefin and vinyl acetate copolymer can be used to produce the sheath in forming the wire 10.

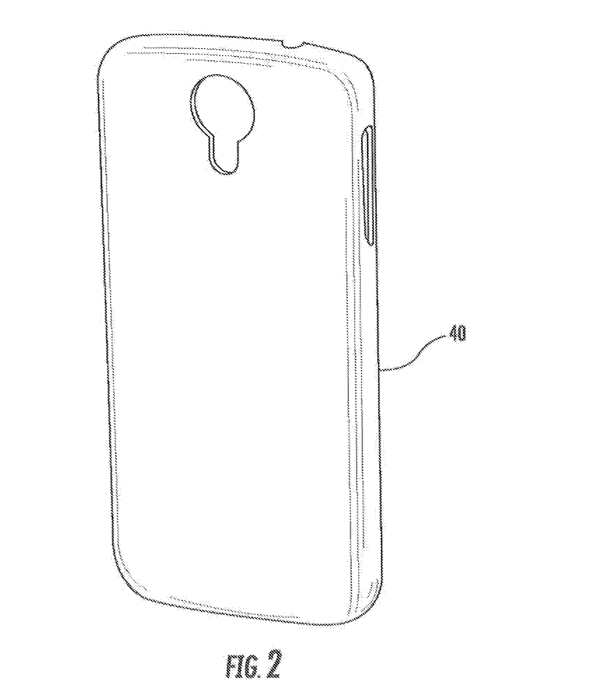

In an alternative embodiment, the polymer composition of the present disclosure can be used to produce protective covers and device handles for electronics. For instance, FIG. 2 illustrates a protective cover 40 for a mobile phone.

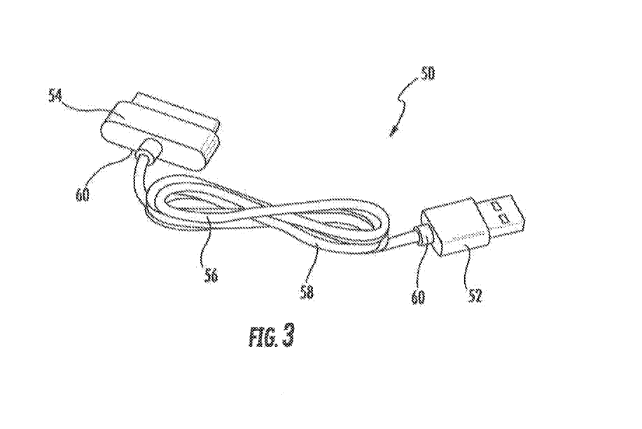

In still another embodiment, the polymer composition of the present disclosure can be used to produce a connector 50 as shown in FIG. 3. The connector 50 includes a first connector 52, such as a USB port, and a second connector 54 that are in electrical communication with each other by a cable 56. In accordance with the present disclosure, the polymer composition may be used to produce the sheath 58 that is part of the cable 56. In addition, the polymer composition may be used to produce a transition sleeve 60. The transition sleeve 60 is positioned around the cable 56 before entering each connector 52 and 54. The polymer composition of the present disclosure is particularly well suited for producing the sleeves 60 because sleeves made from the polymer composition are very resistant to kinking.

In addition to the above, the polymer composition of the present disclosure can be used to produce a variety of different types of articles. The polymer composition can be used to produce films, molded articles, fibers, and the like.

In one application, the polymer composition of the present disclosure is applied to a handle for a consumer good to enhance grip. In one particular embodiment, for instance, the polymer composition can be used to form a grip for a razor. A razor, for instance, may include a head that contains one or more blades. The head can be connected to a stem which can be used to hold the razor during use. For instance, in one embodiment, the stem can be connected to the head in a perpendicular relationship. The stem, for instance, can be made from any suitable thermoplastic material, such as acrylonitrile butadiene styrene (ABS) polymer. The polymer composition of the present disclosure can then be used as an exterior surface or coating on the stem. For instance, in one embodiment, the stem can be over molded with the polymer composition of the present disclosure.

As discussed above, the polymer composition is particularly well suited for being over molded onto a polymeric article. In one embodiment, the polymeric article may be made from a polycarbonate. For instance, the polymeric article may comprise a polycarbonate thermoplastic polymer combined with glass fibers. The glass filled polycarbonate can then be over molded with the polymer composition of the present disclosure. In this manner, the polymer composition forms an exterior surface with enhanced grip or other properties.

The polymer composition of the present disclosure may have other applications as well. For instance, the polymer composition can be used to produce bags, stretch-hooder films, specialty tie-layers, tubing, and the like. The polymer composition can be used to produce dampers and cushions, stoppers, caps and plugs, seals, grommets, gaskets, washers, gears, pulley and pulley components, valves, diaphragms, constant velocity joint boots, and the like. The polymer composition can be used to produce toys and toy component, ergonomic soft grips, device handles such as protective covers for electronics such as mobile phones and tablets, covers for cosmetic products such as compacts, and sporting goods and equipment.

The polymer composition can be used to produce grips and handles, textured surfaces, automotive interior parts, sporting goods, shoe components, baseball bat grips, tennis/badminton racket grips, computer feet, chair armrests, vibration dampening components, protective padding in sports jackets and accessories, beverage tubing, side mirror bellows, shifter bellows, CVJ boots, corrugated air ducts, medical packaging, vacuum cleaner tubing, beverage tubing, and the like. When formed into a film, the composition can be used as a textile backing, a hospital gown, for use in furniture, wound-care patches, breathable nicotine patches, bandages, heat sealable layers, laser markable ID tags for uniforms, and the like. The polymer composition can be used to produce packaging materials such as those mentioned above as well as barrier films, household goods such as containers, and the like. The polymer composition can also be incorporated into moderate performance commodity articles, and the like.

In addition, the properties of the polymer composition and molded part or article produced therefrom may allow for secondary processing such as by joining two molded parts. The secondary processing techniques may include heat sealing, heat lamination, vibrating welding, ultrasonic welding, adhesive welding or adhesive gluing, or radio frequency welding. For instance, two injection molded parts may be welded together by secondary processing such as by heat sealing or radio frequency welding.

As described above, the polymer composition of the present disclosure generally contains a thermoplastic elastomer combined with a second polymer in addition to a flame propagation reducing agent. For instance, in one embodiment, the flame propagation reducing agent may comprise fluoropolymer particles. The fluoropolymer particles may be made from a polytetrafluoroethylene polymer.

In general, the particle size of the flame propagation reducing agent may be less than about 20 microns, such as less than about 15 microns. In one embodiment, for instance, the flame propagation reducing agent particles may have an average particle size such that 50% of the particles have a diameter of less than about 15 microns, such as less than about 12 microns, such as less than about 10 microns, such as less than about 8 microns. In one embodiment, relatively small particles may be used. For instance, the particles may have an average particle size such that 50% of the particles have a diameter of less than about 6 microns, such as less than about 5 microns. At least 50% of the particles have a particle size greater than about 0.01 microns, such as greater than about 0.1 microns, such as greater than about 0.5 microns.

In one particular embodiment, the flame propagation reducing agent may comprise a micronized powder. The micronized powder may have an average particle size such that 50% of the particles have a diameter of less than about 5 microns and 99% of the particles have a diameter of less than about 16 microns. The particles may have a specific surface area of greater than about 2 m²/g, such as greater than about 2.5 m²/g. The fluoropolymer used to produce the particles can have a melt temperature of greater than about 300° C., such as greater than about 310° C., such as greater than about 320° C. Such particles improve abrasion and tear resistance as well as non-stick properties. It was unexpectedly discovered, however, that the particles dramatically and significantly reduce the horizontal flame propagation rate of the polymer composition.

The flame propagation reducing agent of the present disclosure can improve the flame propagation properties of the polymer composition without having to add flame retardants. In one embodiment, however, flame retardants may also be present in the composition. In one embodiment, for instance, non-halogen flame retardants are used.

In one embodiment, the non-halogen flame retardant comprises an organic phosphinate, and particularly a metal phosphinate. For example, the metal phosphinate may comprise an aluminum phosphinate. Other non-halogen flame retardants include polyphosphates, such as ammonium polyphosphate, and/or nitrogen-containing flame retardants, such as a melamine. When present, one or more flame retardants may be contained in the composition in an amount from about 1% to about 30% by weight.

The polymer composition may also contain one or more char promoters. Suitable char promoters include metal hydroxide, alumina trihydrate, boehmite, hydrotalcite, basic magnesium carbonate, calcium aluminate hydrate, talc, clay, or mixtures thereof. In one embodiment, the char promoter comprises a metal hydroxide, such as magnesium hydroxide or aluminum hydroxide.

In one embodiment, a metal hydroxide, particularly an aluminum hydroxide, is incorporated into the polymer composition that includes a coating. For instance, the aluminum hydroxide particles may be coated with an organosilane, a carboxylic acid, or salts thereof. The organosilane may comprise an aminosilane.

When present, the char promoter may be contained in the polymer composition in an amount greater than about 1% by weight, such as in an amount greater than about 2% by weight, such as in an amount greater than about 3% by weight. The char promoter is generally present in an amount less than about 15% by weight, such as in an amount less than about 10% by weight. In one embodiment, the char promoter is present in an amount from about 3% to about 8% by weight.

In one embodiment, the polymer composition may include a high molecular weight silicone. In certain applications, the silicone may combine with the flame propagation reducing agent to further decrease the flame propagation properties of the composition.

In one embodiment, the silicone may comprise an ultrahigh molecular weight silicone. In general, the UHMW-Si may have an average molecular weight of greater than about 100,000 g/mol, such as greater than about 200,000 g/mol, such as greater than about 300,000 g/mol, such as greater than 500,000 g/mol and less than about 5,000,000 g/mol, such as less than about 3,000,000 g/mol, such as less than about 2,000,000 g/mol, such as less than about 1,000,000 g/mol, such as less than about 500,000 g/mol, such as less than about 300,000 g/mol. Generally, the UHMW-Si may have a kinematic viscosity at 40° C. measured according to DIN 51562 of greater than about 100,000 mm²s⁻¹, such as greater than about 200,000 mm²s⁻¹, such as greater than about 1,000,000 mm²s⁻¹, such as greater than about 5,000,000 mm²s⁻¹, such as greater than about 10,000,000 mm²s⁻¹, such as greater than about 15,000,000 mm²s⁻¹ and less than about 50,000,000 mm²s⁻¹, such as less than about 25,000,000 mm²s⁻¹, such as less than about 10,000,000 mm²s⁻¹, such as less than about 1,000,000 mm²s⁻¹, such as less than about 500,000 mm²s⁻¹, such as less than about 200,000 mm²s⁻¹.

The UHMW-Si may comprise a siloxane such as a polysiloxane or polyorganosiloxane. In one embodiment, the UHMW-Si may comprise a dialkylpolysiloxane such as a dimethylsiloxane, an alkylarylsiloxane such as a phenylmethylsilaoxane, or a diarylsiloxane such as a diphenylsiloxane, or a homopolymer thereof such as a polydimethylsiloxane or a polymethylphenylsiloxane, or a copolymer thereof with the above molecular weight and/or kinematic viscosity requirements. The polysiloxane or polyorganosiloxane may also be modified with a substituent such as an epoxy group, a hydroxyl group, a carboxyl group, an amino group or a substituted amino group, an ether group, or a meth(acryloyl) group in the end or main chain of the molecule. The UHMW-Si compounds may be used singly or in combination. Any of the above UHMW-Si compounds may be used with the above molecular weight and/or kinematic viscosity requirements

The ultrahigh molecular weight silicone may be added to the polymer composition as a masterbatch wherein the silicone is dispersed in a carrier polymer. The carrier polymer may comprise, for instance, a polyester polymer, an EVA copolymer, a thermoplastic polyurethane polymer, or the like. The master batch may contain the silicone in an amount from about 10% to about 50% by weight, such as in an amount from about 35% to about 45% by weight.

The silicone may be present in the polymer composition in an amount greater than about 0.1% by weight, such as in an amount greater than about 0.5% by weight. The silicone is generally present in an amount less than about 10% by weight, such as in an amount less than about 5% by weight, such as in an amount less than about 3% by weight.

As described above, the flame propagation reducing agent is blended with a thermoplastic elastomer and a second polymer. The second polymer may comprise a vinyl polymer, an olefin, a carbonate, a polyester, or mixtures thereof. In one embodiment, the second polymer comprises an α-olefin and vinyl acetate copolymer, such as an ethylene vinyl acetate copolymer. In general, the weight ratio between the thermoplastic elastomer and the α-olefin and vinyl acetate copolymer can range from about 10:90 to about 90:10, such as from about 20:80 to about 80:20, such as from about 25:75 to about 75:25, such as from about 35:65 to about 65:35. In one embodiment, the thermoplastic elastomer is present in the polymer composition in an amount greater than about 5 wt. % or in an amount less than about 5 wt. % in comparison to the amount of α-olefin and vinyl acetate copolymer present. In general, formulations of containing an ethylene vinyl acetate copolymer with elastomers and polymers are disclosed in U.S. Pat. No. 4,085,082 to Lamb et al., U.S. Pat. No. 4,243,576 to Fischer et al., and U.S. Pat. No. 4,403,007 to Coughlin, which are incorporated herein by reference.

In addition to ethylene vinyl acetate copolymers, the second polymer may also comprise an ethylene-based polymer containing methylacrylate units, ethylacrylate units, glycidylacrylate units, butylacrylate units, maleic anhydride acrylate units, itaconic anhydride acrylate units, and the like in amounts up to about 35% by weight. Such polymers include ethylene methylacrylate copolymer, ethylene ethylacrylate copolymer, and mixtures thereof.

In one embodiment, the thermoplastic elastomer may comprise a thermoplastic polyester elastomer. For example, the polymer composition may contain a copolyester elastomer such as a segmented thermoplastic copolyester. The thermoplastic polyester elastomer, for example, may comprise a multi-block copolymer. Useful segmented thermoplastic copolyester elastomers include a multiplicity of recurring long chain ester units and short chain ester units joined head to tail through ester linkages. The long chain units can be represented by the formula

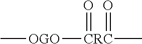

and the short chain units can be represented by the formula

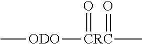

where G is a divalent radical remaining after the removal of the terminal hydroxyl groups from a long chain polymeric glycol having a number average molecular weight in the range from about 600 to 6,000 and a melting point below about 55° C., R is a hydrocarbon radical remaining after removal of the carboxyl groups from dicarboxylic acid having a molecular weight less than about 300, and D is a divalent radical remaining after removal of hydroxyl groups from low molecular weight diols having a molecular weight less than about 250.

The short chain ester units in the copolyetherester provide about 15 to 95% of the weight of the copolyetherester, and about 50 to 100% of the short chain ester units in the copolyetherester are identical.

The term “long chain ester units” refers to the reaction product of a long chain glycol with a dicarboxylic acid. The long chain glycols are polymeric glycols having terminal (or nearly terminal as possible) hydroxy groups, a molecular weight above about 600, such as from about 600-6000, a melting point less than about 55° C. and a carbon to oxygen ratio about 2.0 or greater. The long chain glycols are generally poly(alkylene oxide) glycols or glycol esters of poly(alkylene oxide) dicarboxylic acids. Any substituent groups can be present which do not interfere with polymerization of the compound with glycol(s) or dicarboxylic acid(s), as the case may be. The hydroxy functional groups of the long chain glycols which react to form the copolyesters can be terminal groups to the extent possible. The terminal hydroxy groups can be placed on end capping glycol units different from the chain, i.e., ethylene oxide end groups on poly(propylene oxide glycol).

The term “short chain ester units” refers to low molecular weight compounds or polymer chain units having molecular weights less than about 550. They are made by reacting a low molecular weight diol (below about 250) with a dicarboxylic acid.

The dicarboxylic acids may include the condensation polymerization equivalents of dicarboxylic acids, that is, their esters or ester-forming derivatives such as acid chlorides and anhydrides, or other derivatives which behave substantially like dicarboxylic acids in a polymerization reaction with a glycol.

The dicarboxylic acid monomers for the elastomer have a molecular weight less than about 300. They can be aromatic, aliphatic or cycloaliphatic. The dicarboxylic acids can contain any substituent groups or combination thereof which do not interfere with the polymerization reaction. Representative dicarboxylic acids include terephthalic and isophthalic acids, bibenzoic acid, substituted dicarboxy compounds with benzene nuclei such as bis(p-carboxyphenyl) methane, p-oxy-(p-carboxyphenyl) benzoic acid, ethylene-bis(p-oxybenzoic acid), 1,5-naphthalene dicarboxylic acid, 2,6-naphthalene dicarboxylic acid, 2,7-naphthalene dicarboxylic acid, phenanthralenedicarboxylic acid, anthralenedicarboxylic acid, 4,4′-sulfonyl dibenzoic acid, etc. and C₁-C₁₀ alkyl and other ring substitution derivatives thereof such as halo, alkoxy or aryl derivatives. Hydroxy acids such as p(β-hydroxyethoxy) benzoic acid can also be used providing an aromatic dicarboxylic acid is also present.

Representative aliphatic and cycloaliphatic acids are sebacic acid, 1,3- or 1,4-cyclohexane dicarboxylic acid, adipic acid, glutaric acid, succinic acid, carbonic acid, oxalic acid, itaconic acid, azelaic acid, diethylmalonic acid, fumaric acid, citraconic acid, allylmalonate acid, 4-cyclohexene-1,2-dicarboxylate acid, pimelic acid, suberic acid, 2,5-diethyladipic acid, 2-ethylsuberic acid, 2,2,3,3-tetramethylsuccinic acid, cyclopentanedicarboxylic acid, decahydro-1,5- (or 2,6-) naphthylenedicarboxylic acid, 4,4′-bicyclohexyl dicarboxylic acid, 4,4′-methylenebis(cyclohexyl carboxylic acid), 3,4-furan dicarboxylate, and 1,1-cyclobutane dicarboxylate.

The dicarboxylic acid may have a molecular weight less than about 300. In one embodiment, phenylene dicarboxylic acids are used such as terephthalic and isophthalic acid.

Included among the low molecular weight (less than about 250) diols which react to form short chain ester units of the copolyesters are acyclic, alicyclic and aromatic dihydroxy compounds. Included are diols with 2-15 carbon atoms such as ethylene, propylene, isobutylene, tetramethylene, pentamethylene, 2,2-dimethyltrimethylene, hexamethylene and decamethylene glycols, dihydroxy cyclohexane, cyclohexane dimethanol, resorcinol, hydroquinone, 1,5-dihydroxy naphthalene, etc. Also included are aliphatic diols containing 2-8 carbon atoms. Included among the bis-phenols which can be used are bis(p-hydroxy) diphenyl, bis(p-hydroxyphenyl) methane, and bis(p-hydroxyphenyl) propane. Equivalent ester-forming derivatives of diols are also useful (e.g., ethylene oxide or ethylene carbonate can be used in place of ethylene glycol). Low molecular weight diols also include such equivalent ester-forming derivatives.

Long chain glycols which can be used in preparing the polymers include the poly(alkylene oxide) glycols such as polyethylene glycol, poly(1,2- and 1,3-propylene oxide) glycol, poly(tetramethylene oxide) glycol, poly(pentamethylene oxide) glycol, poly(hexamethylene oxide) glycol, poly(heptamethylene oxide) glycol, poly(octamethylene oxide) glycol, poly(nonamethylene oxide) glycol and poly(1,2-butylene oxide) glycol; random and block copolymers of ethylene oxide and 1,2-propylene oxide and poly-formals prepared by reacting formaldehyde with glycols, such as pentamethylene glycol, or mixtures of glycols, such as a mixture of tetramethylene and pentamethylene glycols.

In addition, the dicarboxymethyl acids of poly(alkylene oxides) such as the one derived from polytetramethylene oxide HOOCCH₂(OCH₂CH₂CH₂CH₂)ₓOCH₂COOH IV can be used to form long chain glycols in situ. Polythioether glycols and polyester glycols also provide useful products. In using polyester glycols, care must generally be exercised to control a tendency to interchange during melt polymerization, but certain sterically hindered polyesters, e.g., poly(2,2-dimethyl-1,3-propylene adipate), poly(2,2-dimethyl-1,3-propylene/2-methyl-2-ethyl-1,3-propylene 2,5-dimethylterephthalate), poly(2,2-dimethyl-1,3-propylene/2,2-diethyl-1,3-propylene, 1,4 cyclohexanedicarboxylate) and poly(1,2-cyclohexylenedimethylene/2,2-dimethyl-1,3-propylene 1,4-cyclohexanedicarboxylate) can be utilized under normal reaction conditions and other more reactive polyester glycols can be used if a short residence time is employed. Either polybutadiene or polyisoprene glycols, copolymers of these and saturated hydrogenation products of these materials are also satisfactory long chain polymeric glycols. In addition, the glycol esters of dicarboxylic acids formed by oxidation of polyisobutylenediene copolymers are useful raw materials.

Although the long chain dicarboxylic acids (IV) above can be added to the polymerization reaction mixture as acids, they react with the low molecular weight diols(s) present, these always being in excess, to form the corresponding poly(alkylene oxide) ester glycols which then polymerize to form the G units in the polymer chain, these particular G units having the structure

.DOCCH₂(OCH₂CH₂CH₂CH₂)ₓOCH₂COOD⁰

when only one low molecular weight diol (corresponding to D) is employed. When more than one diol is used, there can be a different diol cap at each end of the polymer chain units. Such dicarboxylic acids may also react with long chain glycols if they are present, in which case a material is obtained having a formula the same as V above except the Ds are replaced with polymeric residues of the long chain glycols. The extent to which this reaction occurs is quite small, however, since the low molecular weight diol is present in considerable molar excess.

In place of a single low molecular weight diol, a mixture of such diols can be used. In place of a single long chain glycol or equivalent, a mixture of such compounds can be utilized, and in place of a single low molecular weight dicarboxylic acid or its equivalent, a mixture of two or more can be used in preparing the thermoplastic copolyester elastomers which can be employed in the compositions of this invention. Thus, the letter “G” in Formula II above can represent the residue of a single long chain glycol or the residue of several different glycols, the letter D in Formula III can represent the residue of one or several low molecular weight diols and the letter R in Formulas II and III can represent the residue of one or several dicarboxylic acids. When an aliphatic acid is used which contains a mixture of geometric isomers, such as the cis-trans isomers of cyclohexane dicarboxylic acid, the different isomers should be considered as different compounds forming different short chain ester units with the same diol in the copolyesters. The copolyester elastomer can be made by conventional ester interchange reaction.

As described above, the hardness of the thermoplastic elastomer can be varied by varying the amount of hard segments and soft segments. For instance, the thermoplastic elastomer can generally have a hardness of greater than about 10 Shore D, such as greater than about 15 Shore D, such as greater than about 20 Shore D. The hardness is generally less than about 70 Shore D, such as less than about 60 Shore D, such as less than about 55 Shore D, such as less than about 50 Shore D. In one embodiment, a thermoplastic polyester elastomer is used that has a Shore D hardness of from about 20 to about 45. In an alternative embodiment, a thermoplastic polyester elastomer is used that has a Shore D hardness of from about 22 to about 35. In an alternative embodiment, a thermoplastic elastomer may be used that has a Shore D hardness of from about 35 to about 47. And in another alternative embodiment, a thermoplastic elastomer may be used that has a Shore D hardness of from about 50 to about 70.

Copolyether esters with alternating, random-length sequences of either long chain or short chain oxyalkylene glycols can contain repeating high melting blocks that are capable of crystallization and substantially amorphous blocks with a relatively low glass transition temperature. In one embodiment, the hard segments can be composed of tetramethylene terephthalate units and the soft segments may be derived from aliphatic polyether and polyester glycols. Of particular advantage, the above materials resist deformation at surface temperatures because of the presence of a network of microcrystallites formed by partial crystallization of the hard segments. The ratio of hard to soft segments determines the characteristics of the material. Thus, another advantage to thermoplastic polyester elastomers is that soft elastomers and hard elastoplastics can be produced by changing the ratio of the hard and soft segments.

In one particular embodiment, the polyester thermoplastic elastomer has the following formula: -[4GT]ₓ[BT]_{y}, wherein 4G is butylene glycol, such as 1,4-butane diol, B is poly(tetramethylene ether glycol) and T is terephthalate, and wherein x is from about 0.60 to about 0.99 and y is from about 0.01 to about 0.40.

In general, the thermoplastic elastomer is present in the polymer composition in an amount of at least about 5% by weight, such as at least about 10% by weight, such as at least 15% by weight, such as at least 20% by weight but less than about 75% by weight, such as less than about 65% by weight, such as less than about 55% by weight, such as less than about 45% by weight. In one embodiment, the thermoplastic elastomer is present in the polymer composition in an amount from about 20% to about 35% by weight.

The thermoplastic polyester elastomer may comprise a polyester polymer such as a polyalkylene terephthalate copolymer. The polyalkylene terephthalate copolymer may comprise a polyethylene terephthalate glycol-modified copolymer (PET-G) containing cyclohexane dimethanol or a polyethylene terephthalate glycol-modified copolymer containing neopentyl glycol, or a polyethylene terephthalate glycol-modified copolymer containing 2-methy-1,3-propane diol. In one embodiment, for instance, the polyester used in the polymer composition comprises a glycol-modified polyethylene terephthalate in which the glycol is replaced with cyclohexane dimethanol or with neopentyl glycol. For instance, in one embodiment, at least about 5 mol percent, such as at least about 7 mol percent, such as at least about 10 mol percent, such as at least about 15 mol percent of the ethylene glycol may be modified. In general, the ethylene glycol may be modified by less than about 30 mol percent, such as less than about 25 mol percent, such as less than about 20 mol percent, such as less than about 15 mol percent. In certain embodiments, there may be advantages in using a polyester modified with neopentyl glycol, cyclohexane dimethanol, or with 2-methyl-1,3-propane diol because they may improve stress fracture resistance.

The polyester polymer may comprise a polyalkylene terephthalate copolymer, such as a polyethylene terephthalate acid-modified copolymer (PET-A) containing isophthalic acid or a polyethylene terephthalate acid-modified copolymer containing cyclohexane dicarboxylic acid. The polyester polymer may comprise a polyalkylene terephthalate copolymer, such as a polyethylene terephthalate glycol- and acid-modified copolymer containing cyclohexane dimethanol and isophthalic acid, or other combinations.

The thermoplastic elastomer is generally combined with a vinyl ester copolymer and particularly a vinyl ester of acetic acid copolymer. The copolymer contains vinyl ester monomeric units, such as vinyl acetate, in combination with other monomeric units. For instance, the other monomeric units may comprise an olefin, such as an α-olefin. In one embodiment, for instance, the α-olefin comprises ethylene.

The production of ethylene vinyl acetate copolymers can occur using various processes and techniques. In one embodiment, vinyl acetate is first produced.

Vinyl acetate can then be polymerized in bulk, in solution, in an emulsion, or in a suspension. In the case of both polymer and monomer transfer, two mechanisms are possible that occur either at the tertiary carbon or at the acetate group. A radical formed at either of the tertiary carbon atom or at the acetate group can then initiate polymerization and form branched structures. In one embodiment, poly(vinyl acetate) is produced in an emulsion form during an emulsion polymerization process.

In one embodiment, approximately equal quantities of vinyl acetate and water are stirred together in the presence of a suitable colloid-emulsifier system, such as poly(vinyl alcohol) and sodium lauryl sulphate, and a water-soluble initiator such as potassium persulphate. Polymerization can take place over a period of time such as about four hours at relatively low temperatures, such as at temperatures less than about 100° C. The reaction is exothermic and thus, in some systems, cooling can occur during the process. In order to achieve better control of the process and to obtain particles with a small particle size, an initial portion of the monomer can first be polymerized while initiator is steadily added over a period of time. In some embodiments, the reaction occurs in the presence of a buffer, such as sodium acetate, in order to minimize hydrolysis of the vinyl acetate.

When producing an α-olefin and vinyl acetate copolymer, polymerization occurs with polyvinyl acetate in combination with another monomer, such as an ethylene source. Process conditions can be controlled so as to control the amount of vinyl acetate present in the resulting copolymer.

In this regard, the α-olefin and vinyl acetate copolymer used in the present disclosure generally contains greater amounts of the α-olefin in relation to the vinyl acetate. Vinyl acetate, for instance, is generally present in the copolymer in an amount less than about 50 weight %, such as less than about 40 weight %, such as less than about 30 weight %, such as less than about 28 weight %, such as less than about 20 weight %, such as less than about 18 weight %, such as less than about 15 weight %. The vinyl acetate is present in the copolymer generally in an amount greater than about 5 weight %, such as greater than about 7 weight %. Greater amounts of vinyl acetate in the resulting copolymer can, in some embodiments, lead to various disadvantages. For instance, the resulting polymer composition when combined with the thermoplastic elastomer may have an undesirable degree of tackiness and may also present processing problems. On the other hand, greater amounts of vinyl acetate may provide an increased resistance to environmental stress cracking as well as an increase in transparency.

According to the present disclosure, an α-olefin and vinyl acetate copolymer is combined with a thermoplastic elastomer. In general, as the amount of α-olefin and vinyl acetate copolymer content is increased, the polymer composition may exhibit an improvement in viscosity and melt strength. In general, an improvement in melt strength and an increase in viscosity may be obtained using a highly branched α-olefin and vinyl acetate copolymer. On the other hand, in general, an α-olefin and vinyl acetate copolymer with less branching may reduce the viscosity of the polymer composition.

The polymer composition can have a melt flow rate at 190° C. and at 2.16 kg of greater than about 0.1 g/10 mins., such as greater than about 1 g/10 mins., such as greater than about 2 g/10 mins but less than about 12 g/10 mins, such as less than about 10 g/10 mins., such as less than about 8 g/10 mins., such as less than about 6 g/10 mins.

As described above, the hardness of the polymer composition can be varied by varying the amount thermoplastic elastomer and α-olefin and vinyl acetate copolymer. For instance, hardness and other properties can be dependent upon the hardness of the thermoplastic elastomer, ratio of the thermoplastic elastomer to the α-olefin and vinyl acetate copolymer, hardness of the α-olefin and vinyl acetate copolymer, processing conditions, and presence of stabilizers and additives. For instance, the polymer composition can generally have a hardness of greater than about 10 Shore D, such as greater than about 15 Shore D, such as greater than about 20 Shore D. The hardness is generally less than about 70 Shore D, such as less than about 60 Shore D, such as less than about 55 Shore D, such as less than about 50 Shore D, such as less than about 48 Shore D. In one embodiment, the polymer composition has a Shore D hardness of from about 20 to about 35. In an alternative embodiment, the polymer composition has a Shore D hardness of from about 35 to about 47.

In general, the flexural modulus can vary widely depending upon the elastomer selected. In general, the flexural modulus can be from about 10 MPa to about 1,300 MPa when tested at 23° C., such as from about 10 MPa to about 400 MPa,

In addition to the above components, the polymer composition may include various other ingredients. Colorants that may be used include any desired inorganic pigments, such as titanium dioxide, ultramarine blue, cobalt blue, and other organic pigments and dyes, such as phthalocyanines, anthraquinones, Holcomax black 69969 and the like. Other colorants include carbon black or various other polymer-soluble dyes. The colorants can generally be present in the composition in an amount up to about 5 percent by weight.

In one embodiment, the polymer composition can also contain an acid scavenger. An acid scavenger may be used to combine with any acid, such as acetic acid, that may occur during processing or during use of the polymer composition. When present, the acid scavenger may prevent polymer degradation due to the evolution of an acid from the polymer. Examples of acid scavengers include the antioxidants described below.

Antioxidants that may be present in the composition include sterically hindered phenol compounds. The antioxidants may provide thermal stability during and after molding and/or any secondary processing. Examples of such compounds, which are available commercially, are pentaerythritol tetrakis[3-(3,5-di-tert-butyl-4-hydroxyphenyl)propionate] (Irganox 1010, BASF), triethylene glycol bis[3-(3-tert-butyl-4-hydroxy-5-methylphenyl)propionate] (Irganox 245, BASF), 3,3′-bis[3-(3,5-di-tert-butyl-4-hydroxyphenyl)propionohydrazide] (Irganox MD 1024, BASF), hexamethylene glycol bis[3-(3,5-di-tert-butyl-4-hydroxyphenyl)propionate](Irganox 259, BASF), 3,5-di-tert-butyl-4-hydroxytoluene (Lowinox BHT, Chemtura) and n-octadecyl-R-(4-hydroxy-3,5-di-tert-butyl-phenyl)propionate. In one embodiment, for instance, the antioxidant comprises tetrakis[methylene(3,5-di-tert-butyl-4-hydroxyhydrocinnamate)]methane. In an alternative embodiment, the antioxidant may comprise beta-laurylthiopropionate. The antioxidant may be present in the composition in an amount less than 2% by weight, such as in an amount from about 0.1 to about 1.5% by weight.

Light stabilizers that may be present in the composition include sterically hindered amines. Such compounds include 2,2,6,6-tetramethyl-4-piperidyl compounds, e.g., bis(2,2,6,6-tetramethyl-4-piperidyl) sebacate (Tinuvin 770, BASF) or the polymer of dimethyl succinate and 1-(2-hydroxyethyl)-4-hydroxy-2,2,6,6-tetramethyl-4-piperidine (Tinuvin 622, BASF). UV absorbers that may be present in the composition include benzophenones or benzotriazoles. Any suitable benzophenone or benzotriazole may be used in accordance with the present disclosure. The light stabilizer and UV absorber may improve weatherability and may be present in an amount from about 0.1% to about 3% by weight, such as from about 0.5% to about 1.5% by weight.

In one embodiment, the polymer composition may contain a blend of a light stabilizer and a UV absorber. The blend may also provide ultraviolet light resistance and color stability that prevents color fading. In one embodiment, the polymer composition may contain a combination of a behzotriazole or benzophenone UV absorber and a hindered amine light stabilizer such as an oligomeric hindered amine.

Fillers that may be included in the composition include glass beads, wollastonite, loam, molybdenum disulfide or graphite, inorganic or organic fibers such as glass fibers, carbon fibers or aramid fibers. The glass fibers, for instance, may have a length of greater than about 3 mm, such as from 5 to about 50 mm.

Various other stabilizers may also be present in the composition. For instance, in one embodiment, the composition may contain a phosphite, such as a diphosphite. For instance, in one embodiment, the phosphite compound may comprise a pentaerythritol phosphite, a pentaerythritol diphosphite, or a distearyl pentaerythritol diphosphite. The phosphite compound may also comprise bis(2,4-ditert-butylphenyl)pentaerythritol diphosphite. The phosphite compound may also comprise O,O′-Dioctadecylpentaerythritol bis(phosphite). An organophosphite processing stabilizer as described above may be present in the polymer composition in an amount less than about 2% by weight, such as in an amount from about 0.1% to about 1.5% by weight.

In one embodiment, the polymer composition may contain a crosslinking agent. The crosslinking agent may also serve as an impact modifier and/or as a reactive compatibilizer. The crosslinking agent may react with one or more components in the composition. For instance, the crosslinking agent may react with at least one polymer such as the thermoplastic elastomer. For instance, in general, crosslinking the thermoplastic elastomer may improve the melt strength and melt flow properties of the composition making the polymer composition more suitable for processing such as for blow molding or extrusion.

In one embodiment, the crosslinking agent may contain epoxy functionalization. For instance, any suitable epoxy resin that can form crosslinks may be used in the polymer composition. In one embodiment, the epoxy resin may be derived from bisphenol-A such as a poly(bisphenol A-co-epichlorohydrin) glycidyl end-capped resin. In one embodiment, the epoxy resin may be a cresol novolac epoxy resin derived from cresolformaldehyde novolac and epichlorohydrin. In general, the epoxy resin may be present in the polymer composition in an amount of less than about 3% by weight, such as less than about 1.5% by weight, such as less than about 1% by weight but greater than about 0.1% by weight.

In one embodiment, the crosslinking agent may include epoxy-functional methacrylic monomer units. As used herein, the term methacrylic generally refers to both acrylic and methacrylic monomers, as well as salts and esters thereof, e.g., acrylate and methacrylate monomers. Epoxy-functional methacrylic monomers that may be utilized as the crosslinking agent include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate. In general, the epoxy-functional methacrylic monomer units may be present in the polymer composition in an amount of less than about 7.5% by weight, such as less than about 6% by weight but greater than about 0.1% by weight, such as greater than about 1% by weight, such as greater than about 2.5% by weight, such as greater than about 5% by weight.

Another ingredient that may be present in the polymer composition is a lubricant. The lubricant may comprise paraffins, montanic esters, partially hydrolyzed montanic esters, stearic acids, polar and/or non-polar polyethylene waxes, olefin oligomers, silicone oils, polyalkylene glycols, perfluoroalkyl ethers, and mixtures thereof. In one embodiment, the lubricant comprises an ester of a montanic acid, such as esters of a multifunctional polyol and montanic acids. The lubricant may include saturated hydrocarbon acids with a chain length of from 29 to 32 carbon atoms. The lubricant may be present in the polymer composition in an amount from about 0.05% to about 5% by weight, such as from about 0.1% to about 1% by weight.

Another component that may be present in the polymer composition is a coupling agent. The coupling agent may comprise a titanate, a zirconate, or an aluminate organometallic. The organometallic coupling agent can be capable of bonding dissimilar materials contained in the composition. One example of a coupling agent is isooctanol hydrogen phosphate zirconium. The coupling agent can be present in the composition in an amount from about 0.05% to about 3% by weight, such as from about 0.1% to about 1% by weight.

In one embodiment, the polymer composition may also contain a crystallization accelerator or nucleating agent. The nucleating agent may comprise a filler such as a mineral filler. Examples include talc, clay, silica, calcium silicate, mica, calcium carbonate, titanium dioxide, boron nitride, and the like. The nucleating agents induce drystallization of the polymers. Other nucleating agents that may be used include inorganic oxides or carbonates or other salts of carboxylic acid oligomers. The nucleating agent may be present in the composition in an amount from about 0.5% to about 50% by weight, such as in an amount from about 0.5% to about 15% by weight.

In order to produce molded articles in accordance with the present disclosure, the different components of the polymer composition can be dry blended together in a drum tumbler or in a high intensity mixer. The premixed blends can then be melt blended and extruded as pellets. The pellets can then be used in an injection molding process, or extrusion process. The composition can also be process to form films such as cast films or blown films.

In one embodiment, for injection molding, the polymer composition may comprise an ethylene vinyl acetate random copolymer and a thermoplastic polyester elastomer.

The present disclosure may be better understood with reference to the following example.

### Example

Various different polymer compositions were formulated in accordance with the present disclosure and tested for flame resistant properties. Specifically, the polymer compositions were tested according to Underwriters Laboratories Test 94 according to the 75 mm Horizontal Burn Test.

Various different compositions were formulated, premixed, melt-blended and extruded into pellets in a WLE-25 extruder having an SC-202 screw design under the following temperature settings:

| Barrel Zone | Temp Setting (° C.) |
|---|---|
| 1 | 50-80 |
| 2 | 120-130 |
| 3 | 120-180 |
| 4 | 160-190 |
| 5 | 160-190 |
| 6 | 160-190 |
| Die head temp | 180-200 |
| Melt Temp | 180-220 |

The screw speed was set at about 250 RPM with 50% torque. The typical die vacuum was about 25 mm of Hg and throughput was about 40-50 lbs/hr.

Each of the formulations was conventionally injection molded, after drying of pellets at 60-75° C. for 4 hr to a moisture level of 0.004% using a 4 oz. Demag 661 molding machine. The temperature settings recommended are as follows:

| Zone | Temperature Setting (° C.) |
|---|---|
| Rear Barrel | 170-175 |
| Middle Barrel | 180-190 |
| Front Barrel | 180-190 |
| Nozzle | 180-190 |
| Melt | 180-190 |
| Moveable Mold | 20-40 |
| Stationary Mold | 20-40 |

The different formulations were tested for various physical properties in addition to being tested according to the UL-94 Horizontal Burn Test. The physical properties were tested according to ISO Test No. 178. The tests were performed on a 64 mm support span. Tests were run on the center portions of uncut ISO 3167 multi-purpose bars. The testing speed is 2 mm/min.

The following formulations were tested and the following results were obtained:

| | Sample | Sample | Sample | Sample | Sample | Sample | Sample |
|---|---|---|---|---|---|---|---|
| | No. 1 | No. 2 | No. 3 | No. 4 | No. 5 | No. 6 | No. 7 |
| Thermoplastic | 55.5 | 100 | 54.8 | 54.8 | 53.8 | 52.8 | 53.8 |
| polyester | | | | | | | |
| elastomer with 25 | | | | | | | |
| Shore D hardness | | | | | | | |
| Ethylene vinyl | 40 | | 40 | | | | |
| acetate copolymer | | | | | | | |
| (33% vinyl acetate | | | | | | | |
| content) | | | | | | | |
| Ethylene vinyl | | | | 40 | 40 | 40 | 40 |
| acetate copolymer | | | | | | | |
| (28% vinyl acetate | | | | | | | |
| content) | | | | | | | |
| Diphosphonite | 0.5 | | 0.5 | 0.5 | 0.5 | 0.5 | 0.5 |
| stabilizer | | | | | | | |
| Oligomeric | 0.2 | | 0.5 | 0.5 | 0.5 | 0.5 | 0.5 |
| hindered amine | | | | | | | |
| light stabilizer | | | | | | | |
| Benzotriazole | 0.2 | | 0.5 | 0.5 | 0.5 | 0.5 | 0.5 |
| ultraviolet light | | | | | | | |
| absorber | | | | | | | |
| Oligomeric, high | 0.2 | | 0.5 | 0.5 | 0.5 | 0.5 | 0.5 |
| molecular weight | | | | | | | |
| hindered amine light | | | | | | | |
| stabilizer | | | | | | | |
| Stearyl erucamide | 0.3 | | 0.3 | 0.3 | 0.3 | 0.3 | 0.3 |
| lubricant | | | | | | | |
| Talc | 0.1 | | 0.1 | 0.1 | 0.1 | 0.1 | 0.1 |
| Ethylene glycidyl | 1 | | 1 | 1 | 1 | 1 | 1 |
| methacrylate | | | | | | | |
| copolymer | | | | | | | |
| Ultrahigh molecular | | | 2 | 2 | 2 | 2 | 2 |
| weight | | | | | | | |
| polydimethylsiloxane | | | | | | | |
| containing 50% by | | | | | | | |
| weight EVA | | | | | | | |
| copolymer carrier | | | | | | | |
| Micronized PTFE | 2 | | | | 1 | 2 | |
| D50 = 4 microns* | | | | | | | |
| PTFE particles | | | | | | | 1 |
| D50 = 12 microns* | | | | | | | |
| MFR g/min | 21.62 | 13 | 25 | 20 | 20.89 | 21.23 | 22.89 |
| (190° C./2.16 g) | | | | | | | |
| Flex koduius (23° C.) | 13 | 20 | 12 | 16 | 12 | 11 | 10 |
| Flex stress at 3.5% | 0.52 | 0.8 | 0.45 | 0.55 | 0.45 | 0.45 | 0.42 |
| Hardness Shore A | 71 | 77 | 71 | 75 | 71.8 | 71.8 | 71.6 |
| UL-94 HB rate | 63 | 76 | 108.5 | 113.4 | 82 | 73.8 | 59.2 |
| (mm/min) | | | | | | | |
| UL-94 HB time for | 71.3 | 59 | 41.5 | 39.7 | 55 | 61 | 76 |
| 75 mm (sec) | | | | | | | |

*measured using laser diffraction particle size analyzer

As shown above, use of a flame propagation reducing agent in accordance with the present disclosure can dramatically improve the flame propagation rates of the polymer compositions.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer composition comprising:
a thermoplastic polyester elastomer;
a second polymer;
a flame propagation reducing agent comprising fluoropolymer particles, the fluoropolymer particles having a particle size such that at least about 50% of the particles have a diameter of less than about 20 microns; and
wherein the polymer composition has a horizontal burn time of greater than about 60 seconds at a test length of 75 mm.

2. A polymer composition as defined in claim 1, wherein the fluoropolymer particles comprise a polytetrafluoroethylene polymer.

3. A polymer composition as defined in claim 1, wherein the fluoropolymer particles have a particle size such that at least about 50% of the particles have a diameter of less than about 7 microns.

4. A polymer composition as defined in claim 1, wherein the fluoropolymer particles are present in the composition in an amount from about 0.5% to about 5% by weight.

5. A polymer composition as defined in claim 1, wherein the composition further contains an ultrahigh molecular weight silicone.

6. A polymer composition as defined in claim 1, wherein the flame propagation reducing agent is present in the composition in an amount sufficient for the horizontal burn time to increase by at least about 10% for a 75 mm test length, in comparison to an identical composition not containing the flame propagation reducing agent.

7. A polymer composition as defined in claim 1, wherein the second polymer comprises an α-olefin and vinyl acetate copolymer.

8. A polymer composition as defined in claim 7, wherein the α-olefin and vinyl acetate copolymer contains vinyl acetate in an amount from about 3 weight % to about 50 weight %, the weight ratio between the thermoplastic polyester elastomer and the α-olefin and vinyl acetate copolymer being from about 20:80 to about 80:20.

9. A polymer composition as defined in claim 7, wherein the α-olefin and vinyl acetate copolymer comprises an ethylene vinyl acetate copolymer.

10. A polymer composition as defined in claim 1, wherein the composition does not contain any chlorine based, bromine-based, phosphorus-based, or nitrogen-based flame retardants.

11. A polymer composition as defined in claim 1, wherein the polymer composition further comprises a lubricant.

12. A polymer composition as defined in claim 1, wherein the polymer composition further comprises a coupling agent.

13. A polymer composition as defined in claim 1, wherein the polymer composition further comprises a crosslinking agent comprising an epoxy functional group.

14. A polymer composition as defined in claim 1, wherein the thermoplastic polyester elastomer contains soft segments and hard segments.

15. A polymer composition as defined in claim 1, wherein the thermoplastic polyester elastomer comprises a multi-block copolyester elastomer.

16. A polymer composition as defined in claim 14, wherein the hard segments comprise ester units and the soft segments comprise an aliphatic polyester or a polyether glycol.

17. A polymer composition as defined in claim 1, wherein the thermoplastic polyester elastomer has the following formula: -[4GT]x[BT]y, wherein 4G is 1,4-butane diol, B is poly(tetramethylene ether glycol) and T is terephthalate, and wherein x is about 0.6 to about 0.99 and y is about 0.01 to about 0.40.

18. A molded article made from the polymer composition defined in claim 1.

19. A cable or wire comprising a coating made from the polymer composition defined in claim 1.

20. A molded article as defined in claim 18, wherein the article comprises a portion of a housing for a consumer electronic product, a grip, a handle, a telephone case, a camera case, a computer case, an automotive interior, a sporting good, a shoe component, or a vibration dampening component.

21. A molded article as defined in claim 18, wherein the flame propagation reducing agent is present on a surface of the article.
